(19) United States
(12) Patent Application Publication
(10) Pub. No.: US 2017/0196235 A1
(43) Pub. Date: Jul. 13, 2017

(54) CLOUDINESS-INHIBITING AGENT FOR TEA BEVERAGE

(71) Applicant: KOHJIN LIFE SCIENCES CO., LTD., Tokyo (JP)

(72) Inventors: Eiji NAKAO, Oita (JP); Yoshie YASUMATSU, Oita (JP); Kenichi ASON, Oita (JP)

(73) Assignee: KOHJIN LIFE SCIENCES CO., LTD., Tokyo (JP)

(21) Appl. No.: 15/326,233

(22) PCT Filed: Jul. 15, 2015
(86) PCT No.: PCT/JP2015/070224

§ 371 Date: Jan. 13, 2017

(30) Foreign Application Priority Data
Jul. 16, 2014 (JP) 2014-146229

(51) Int. Cl. A23F 3/16

(52) U.S. Cl. CPC A23F 3/16

(57) ABSTRACT

[Problem] To produce, with a method that is low-cost and has a low environmental impact, a cloudiness-inhibiting agent that is highly safe and has no taste which has a cloudiness-inhibiting effect in a tea beverage. Also, to make effective use of yeast cell body residue produced as a byproduct of yeast extract.

[Means for Solving the Problem] Yeast cell body residue remaining after removing useful extract from yeast is suspended in water and heated, after which the suspension is subjected to centrifugation to obtain a supernatant. This fraction has an amount of RNA content per solid content of the yeast extract of at least 50 wt %, dietary fiber content of at least 5 wt %, and protein content of at least 10 wt %. Mannan content is at least 60 wt % of the dietary fiber. This fraction can be used to inhibit cloudiness for a tea beverage.

### FIELD OF THE INVENTION

The invention of the instant application relates to a cloudiness-inhibiting agent for a tea beverage which is obtained from yeast cell body residue.

### BACKGROUND OF THE INVENTION

In recent years, various tea beverages in plastic bottles, cans, or the like have become widespread. Even when a tea beverage is transparent immediately after extraction from tea leaves, the tea beverage often becomes cloudy (murky) afterwards due to effects of polyphenols and the like which are a component of the tea. In particular, when the tea beverage is cooled, the development of cloudiness is promoted. Also, cloudiness may develop due to long-term storage. Such cloudiness occurring in a manufacturing process, distribution, or during storage of a tea beverage is often disliked due to being confused for reduced quality of appearance, containing microorganisms, or the like. A mechanism causing cloudiness in a tea beverage is complex, and although studies have been conducted, the complete formation mechanism is not yet clear.

Examples of reported methods for inhibiting cloudiness of a tea beverage include a method adding tyrosine (Patent Literature 1); a method adding a saccharide (Patent Literature 2); a method adding cyclodextrin (Patent Literature 3); a method adding chondroitin sulfate (Patent Literature 4); a method using an enzyme treatment on a tea beverage (Patent Literature 5); a method rapidly cooling a tea extract liquid and removing cloudiness through centrifugal separation and diatomaceous earth filtration (Patent Literature 6); and the like.

However, each of these methods is complex, difficult work, and may alter the taste of the tea beverage or not be fully effective, for example.

Meanwhile, yeast contains components such as nucleic acid, amino acid, and peptides. An extract of yeast can be used as a source of glutathione (a pharmaceutical), or as yeast extract (a natural seasoning). However, making effective use of yeast cell body residue, which is produced in large quantities as a byproduct during extraction, has become a topic of consideration. Various methods of producing yeast extract are known which use extracting enzymes, mediums, and the like. Examples include the method of Patent Literature 7.

Cell body residue which remains after yeast extract and the like is extracted from yeast contains glucan, mannan, mannoprotein, proteins, lipids, and nucleic acids as primary components. A plurality of known publications address methods of treating such yeast cell body residue and methods of making effective use of the same. For example, Patent Literature 8 discloses a method of treating waste water by making a yeast extract residue soluble using a specific enzyme. Patent Literature 9 describes a method of producing mannose by causing a yeast extract residue to be assimilated by microorganisms. Patent Literature 10 describes a method of obtaining a medicinal composition by alkali treatment of a yeast extract residue, followed by irrigation thereof. Patent Literature 11 describes a method of obtaining a microorganism culture substrate material by allowing a cell wall lytic enzyme or the like to act on yeast extract residue. Given the situation, a more effective method of using yeast cell body residue is desired.

### RELATED ART

### Patent Literature

Patent Literature 1: Japanese Patent Laid-open Publication No. 2005-333815
Patent Literature 2: Japanese Patent Laid-open Publication No. S50-006797
Patent Literature 3: Japanese Patent Laid-open Publication No. H04-255792
Patent Literature 4: Japanese Patent Laid-open Publication No. 2004-305090
Patent Literature 5: Japanese Patent Laid-open Publication No. H09-172969
Patent Literature 6: Japanese Patent Laid-open Publication No. H04-311348, Japanese Patent Laid-open Publication No. 2007-167052
Patent Literature 7: Japanese Patent Laid-open Publication No. H05-252894, Japanese Patent Laid-open Publication No. H06-113789, Japanese Patent Laid-open Publication No. H09-056361
Patent Literature 8: Japanese Patent Laid-open Publication No. H07-184640
Patent Literature 9: Japanese Patent Laid-open Publication No. H10-057091
Patent Literature 10: Japanese Patent Laid-open Publication No. 2001-055338
Patent Literature 11: Japanese Patent Laid-open Publication No. 2007-006838

### SUMMARY OF THE INVENTION

### Problems to be Solved by the Invention

An issue to be resolved is to easily inhibit cloudiness of a tea beverage and maintain clarity of the tea beverage. To do this, a substance is preferably used which is highly safe for foods and beverages and has no taste, and which can be manufactured at a low cost with a method having a low environmental impact. Another issue is to make effective use of yeast cell body residue, which is produced as a byproduct of yeast extract.

As a result of thorough research to resolve the above-noted issues, the inventors of the present invention have discovered that extract of yeast residue is effective in inhibiting cloudiness of a tea beverage.

Specifically, the present invention relates to:

(1) A cloudiness-inhibiting agent for a tea beverage, composed of yeast extract;
(2) The cloudiness-inhibiting agent for the tea beverage according to (1) above, in which an amount of RNA content per solid content of the yeast extract is at least 50 wt %, protein content is at least 10 wt %, and dietary fiber content is at least 5 wt %;
(3) The cloudiness-inhibiting agent for the tea beverage according to (2) above, in which mannan content makes up at least 60 wt % of the dietary fiber;
(4) The cloudiness-inhibiting agent for the tea beverage according to any of (1) to (3) above, in which the yeast extract is obtained using yeast cell body residue;
(5) The cloudiness-inhibiting agent for the tea beverage according to any of (1) to (4) above, in which the yeast is Candida utilis; and
(6) A method of inhibiting cloudiness in a tea beverage by including 0.01 to 1 wt % of the cloudiness-inhibiting agent for the tea beverage according to any of (1) to (5) in the tea beverage.

### Effect of the Invention

According to the present invention, a yeast extract having an excellent effect in inhibiting cloudiness in a tea beverage can be obtained from Torula yeast (Candida utilis), which is edible and known to be safe. By adding a small amount of the yeast extract to various kinds of tea beverages, cloudiness occurring in the tea beverages can be inhibited and quality can be improved. Therefore, the yeast extract can be used as a cloudiness-inhibiting agent for the tea beverages. Such yeast extract has no taste, and therefore does not impart a foreign taste to tea beverages to which the yeast extract is added. Also, unlike cases using plants or animals as raw materials, there is little risk of supply instability, price fluctuation, and quality variation when using yeast as the raw material. Moreover, cell body residue which remains after extracting the yeast extract or the like can be used as the raw material, and a yeast extract inhibiting flocculation/settling arising in foods and beverages can be obtained from this with a simple process. Cell body residue of Torula yeast is produced in large quantities as a byproduct of manufacturing yeast extract (a seasoning) and other useful constituents. The present invention is able to make effective use of this yeast cell body residue, and is therefore also very advantageous in view of cost and reduction in industrial waste.

### MODE FOR CARRYING OUT THE INVENTION

Hereafter, a concrete description of the present invention is given. The yeast referenced in the present invention is a non-genetically modified yeast that may be used in food manufacture. Specific examples may include Candida utilis, Saccharomyces cerevisiae, and the like. Of these, Candida utilis is preferred.

The yeast cell body residue of the present invention is a residue remaining after yeast extract or useful constituents have been removed from yeast by an extraction process using one or more of hot water, acid/alkaline solution, autolysis, mechanical pulverization, a cell wall lytic enzyme, a proteolytic enzyme, ribonuclease, or deaminase. Examples include “KR yeast” manufactured by Kohjin Life Sciences Co., Ltd. Such residue is typically primarily composed of glucan, mannan, protein, lipids, and nucleic acid. Structurally, the glucan, mannan, protein, and other components form a conjugate and are expected to form strong bonds. Residue remaining after acid extraction from yeast, in particular, is highly active and is preferably used as the yeast cell body residue used to manufacture the cloudiness-inhibiting agent for the tea beverage according to the present invention.

A process of obtaining yeast extract inhibiting cloudiness in the tea beverage according to the present invention is, first, to wash the above-described yeast cell body residue with water. Specifically, water is added to the yeast cell body residue and a cell body suspension is prepared having a concentration of approximately 10 wt % of dried cell body weight. Preferably, the pH of the cell body suspension is adjusted to a weakly acidic region (pH 4.0 to 5.0), supernatant is removed by centrifugation, and the cleaned yeast cell body residue is obtained. This cleaning process is performed once, or two or more times. Next, water is added to the cleaned yeast cell body residue and the cell body suspension is prepared having a concentration of approximately 10 wt % of dried cell body weight, then the pH is adjusted to be neutral. The suspension is heated to between 70 and 100° C., and preferably to between 75 and 85° C. A heat treatment duration is preferably between 5 and 15 minutes, and is more preferably between 8 and 12 minutes. Next, sediment is removed with a centrifugal separator and a fraction containing RNA, dietary fiber, and protein is obtained as the supernatant. Yeast extract in which an amount of RNA content per solid content of the yeast extract is at least 50 wt %, and preferably at least 60 wt %; dietary fiber content is at least 5 wt %, and preferably at least 10 wt %; and protein content is at least 10 wt %, and preferably at least 12 wt %, has a high cloudiness-inhibiting effect on the tea beverage. Moreover, the effect is even higher when mannan content makes up at least 60 wt %, and preferably at least 70 wt %, of the dietary fiber. Meanwhile, as constituents having a strong taste, inosinic acid, guanylic acid, and glutamic acid content is preferably low.

An HPLC method is used in the present invention to measure the RNA content. GS-320HQ is used as a separation column, and 0.1 M sodium phosphate buffer (pH 7.0) is used as a mobile phase. Detection is performed at UV 260 nm. The RNA content is found from an area of a peak obtained by injecting the yeast extract. A hydrolysis method is used to measure the content amount of protein in the yeast extract. After hydrolyzing the yeast extract in 6 N hydrogen chloride at 110° C. for 24 hours, pretreatment is performed and measurement is conducted with a fully automatic amino acid analyzer (manufactured by Hitachi Ltd.). The hydrolysis method is used to measure the dietary fiber content. The yeast extract is hydrolyzed in 1 N sulfuric acid at 110° C. for 3.5 hours and is neutralized, after which mannose and glucose (hydrolysis products) are measured using liquid chromatography, and are converted to glucan/mannan. An RI detector is used for detection, an SP810 (Shodex) is used for the separation column, and ultrapure water is used for the mobile phase.

The yeast extract obtained using the manufacturing method described above, with yeast cell body residue as the raw material, can be used without alteration as a cloudiness-inhibiting agent for a tea beverage. Alternatively, when necessary, the yeast extract may be blended with other soluble constituents to produce a cloudiness-inhibiting agent. The agent is particularly effective with black teas as a field of use, but can be used in a broad range of tea beverages.

The tea beverage of the present invention is not particularly limited. However, specific examples may include a black tea beverage, a green tea beverage, a guava tea beverage, a coffee beverage, and the like. Intensity of the effect of the cloudiness-inhibiting agent according to the present invention differs according to the type, pH, and base material concentration of the beverage. Therefore, a preferred blending amount differs according to the type, pH, and concentration of the beverage. However, broadly speaking, the preferred blending amount is 0.01 to 1 wt % (as dried yeast extract), preferably 0.025 to 0.5 wt %, and more preferably 0.1 to 0.3 wt %.

The present invention is described in detail in exemplary embodiments below.

### <Exemplary Manufacture>

Using a 10 N sulfuric acid, a 10% cell body suspension of Candida utilis Cs 7529 strain (FERM BP-1656 strain) was adjusted to a pH of 3.5, then was subjected to a heat treatment at 60° C. for 30 minutes, after which the suspension was separated into yeast extract and yeast cell body residue with a centrifugal separator. After this, water was added to the yeast cell body residue and a 15 wt % (dried weight) cell body suspension was prepared. After adjusting 2.4 kg of the 15% concentration yeast residue suspension to pH 4.8, solids and supernatant were separated by a centrifuge (Hitachi Centrifuge: CR21N) and the solids were collected. The solids were suspended in water, and solids and supernatant were once again separated by a centrifuge, and cleaned yeast cell body residue was obtained as the solids. The solids were suspended in water and adjusted to a 15 wt % (dried weight) suspension, after which the suspension was adjusted to a pH of 7.0. The suspension was heat treated at 80° C. for 10 minutes, then cooling was performed with cool water. After this, the supernatant was collected by the centrifuge; concentrated by an evaporator; and freeze-dried to obtain approximately 30 g powdered yeast extract, which was designated as a cloudiness-inhibiting agent for a tea beverage. In the cloudiness-inhibiting agent, RNA content was 70.6%, dietary fiber content was 14.2 wt %, and protein content was 15.3 wt %. Mannan content made up 85.5 wt % of the dietary fiber.

### <Embodiment 1> Cloudiness Inhibiting Trial in Black Tea

A teabag containing 3.5 g of tea leaves (“Saara Premium Assam,” Brook's Co., Ltd.) was immersed in 200 g hot (distilled) water at a temperature of approximately 98° C. and was steeped for 2 minutes. After steeping, the teabag was removed. The solution was then filtered through a 10 μm filter in order to remove the fine tea leaves. The black tea produced was cooled to room temperature, after which 0.1 wt % of the cloudiness-inhibiting agent obtained in the exemplary manufacture was added to the black tea. The black tea with cloudiness-inhibiting agent obtained in this way was placed in a transparent glass bottle and refrigerated, and cloudiness was observed over time.

### Embodiment 2

Embodiment 2 was conducted similarly to Embodiment 1 except that 0.05 wt % of the cloudiness-inhibiting agent was added in Embodiment 1.

### Embodiment 3

Embodiment 3 was conducted similarly to Embodiment 1 except that 0.025 wt % of the cloudiness-inhibiting agent was added in Embodiment 1.

### Comparative Example 1

Comparative Example 1 was conducted similarly to Embodiment 1 except that the cloudiness-inhibiting agent was not added in Embodiment 1.

### Comparative Example 2

Comparative Example 2 was conducted similarly to Embodiment 1 except that 0.1 wt % of tyrosine was added in Embodiment 1.

As a result of evaluation, cloudiness occurred immediately after refrigeration in Comparative Examples 1 and 2, whereas cloudiness was inhibited in Embodiments 1, 2, and 3. Moreover, cloudiness was inhibited in Embodiments 1, 2, and 3 even after two months of refrigeration. External appearances one day after beginning cooling are shown in FIGS. 1 to 2.

### INDUSTRIAL APPLICABILITY

As described above, by adding the cloudiness-inhibiting agent for tea beverages manufactured in the present invention ahead of time to a tea beverage where cloudiness may occur, cloudiness occurring during storage is inhibited, and accordingly a reduction in quality can be prevented. The cloudiness-inhibiting agent of the present invention can also be used in processed foods containing tea constituents.

### BRIEF DESCRIPTION OF THE DRAWINGS

FIG. 1 is a photograph showing results of a cloudiness inhibiting trial in black tea (from right, Embodiment 1, Embodiment 2, Embodiment 3, Comparative Example 1).

FIG. 2 is a photograph showing results of the cloudiness inhibiting trial in black tea (from right, Comparative Example 2, Embodiment 1, Comparative Example 1).

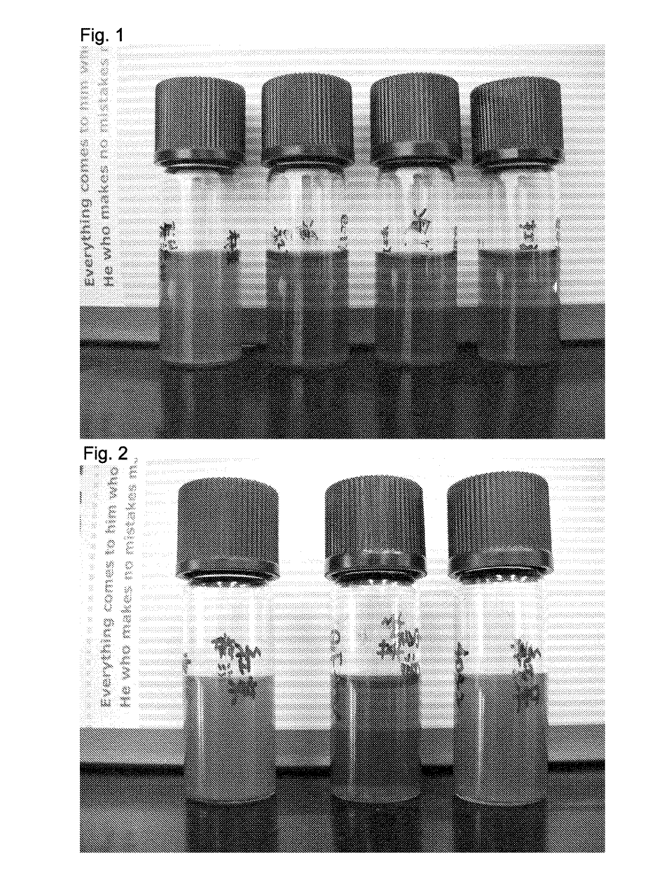

1. A cloudiness-inhibiting agent for a tea beverage, comprising yeast extract.

2. The cloudiness-inhibiting agent for the tea beverage according to claim 1, wherein an amount of RNA content per solid content of the yeast extract is at least 50 wt %, protein content is at least 10 wt %, and dietary fiber content is at least 5 wt %.

3. The cloudiness-inhibiting agent for the tea beverage according to claim 2, wherein mannan content makes up at least 60 wt % of the dietary fiber.

4. The cloudiness-inhibiting agent for the tea beverage according to claim 1, wherein the yeast extract is obtained using yeast cell body residue.

5. The cloudiness-inhibiting agent for the tea beverage according to claim 1, wherein the yeast is Candida utilis.

6. A method of inhibiting cloudiness in a tea beverage which includes 0.01 to 1 wt % of the cloudiness-inhibiting agent for the tea beverage according to claim 1 in the tea beverage.
